(19) United States
(12) Patent Application Publication
(10) Pub. No.: US 2005/0097197 A1
(43) Pub. Date: May 5, 2005

(54) Web browser control for customer support

(75) Inventor: Christopher R. Vincent, Arlington, MA (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, Armonk, NY (US)

(21) Appl. No.: 10/680,282

(22) Filed: Oct. 7, 2003

(51) Int. Cl. G06F 15/16; G06F 15/173

(52) U.S. Cl. 709/223; 709/224; 709/217

(57) ABSTRACT

Systems, methods and computer readable mediums are provided for supporting a user from a remote computer. In one embodiment, a control embedded in a web page that is currently being viewed by a web browser is activated, and source code is received from the remote computer. The control is used to execute the source code received from the remote computer so as to read and/or modify state information of the web browser. In another embodiment, a message from a control embedded in a web page that is currently being viewed by a web browser executing on the remote computer is received at the customer service computer. Source code is sent from the customer service computer to the control so as to cause the control to read and/or modify state information of the web browser executing on the remote computer.

### BACKGROUND OF THE INVENTION

1. Field of the Invention

This invention generally relates to the field of web sites, and more specifically to customer support for a web site.

2. Description of Related Art

As the popularity of the Internet increases, consumers are increasingly using the Internet to conduct business, organize their lives and access information. Users today use the World Wide Web (Web) to do their banking, make stock trades, review account information and perform other tasks involving extensive interaction with Graphical User Interfaces (GUIs). GUIs often have required formats in which information must be entered and required sequences that must be adhered to, in order to properly interact with the GUI. Sometimes, however, GUIs can be difficult to understand and formats are not clearly defined. This can be time consuming to manage and tedious for users. It is common for users to abandon tasks in the middle of execution because they do not understand the GUI or simply cannot enter information properly.

Popular web browsers utilize dynamic HTML (DHTML), which includes dynamic scripting languages such as JavaScript. DHTML allows scripting languages, such as JavaScript code within a web page, to be used to query and dynamically modify the current HTML content at run-time, without interrupting the user experience. These web browsers also support methods to augment DHTML with other code units, such as ActiveX controls, browser plug-ins and Java applets.

Customer support is often employed to aid users through the process of interacting with a web GUI. Customer support for commercial web sites is usually performed via a combination of email, telephone and instant messaging. Customers typically send messages referencing error codes or describing a problem and asking for help. Even when instant messaging is used for this communication, however, it can be difficult to describe problems accurately. Additionally, it can be difficult for customer service/technical support representatives to reproduce the reported problems.

One solution to this customer support problem is screen sharing. Screen sharing, however, presents significant privacy concerns for customer service, since a user must generally share their entire desktop, specific windows, or a specific physical region of the screen. Customers may not want to give customer service access to their computer because of sensitive data on the computer or general privacy concerns.

Therefore a need exists to overcome the problems discussed above, and particularly for a way to more efficiently offer customer support on web pages.

### SUMMARY OF THE INVENTION

Briefly, in accordance with the present invention, disclosed is a system, method and computer readable medium for providing support to a user from a remote computer.

One embodiment of the present invention provides a method for providing support to a user from a remote computer. According to the method, a control embedded in a web page that is currently being viewed by a web browser is activated, and source code is received from the remote computer. The control is used to execute the source code received from the remote computer so as to read and/or modify state information of the web browser. Preferably, the state information of the web browser includes form information entered into at least one form field of the web page that is currently being viewed by the web browser.

Another embodiment of the present invention provides a method for providing support to a user of a remote computer from a customer service computer. According to the method, a message from a control embedded in a web page that is currently being viewed by a web browser executing on the remote computer is received at the customer service computer. Source code is sent from the customer service computer to the control so as to cause the control to read and/or modify state information of the web browser executing on the remote computer.

Further embodiments of the present invention provide computer readable mediums, controls, and customer support applications for implementing such methods.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2 is a detailed block diagram of a preferred embodiment of the system of the present invention.

FIG. 3 is a flowchart depicting the overall operation and control flow of one embodiment of the present invention.

FIG. 4 is a flowchart depicting the operation and control flow of the control activation process of one embodiment of the present invention.

FIG. 5 is a flowchart depicting the operation and control flow of the troubleshooting process of one embodiment of the present invention.

FIG. 6 is an illustration of a web page including an embedded control in one embodiment of the present invention.

FIG. 7 is an illustration of an instant message window used during the troubleshooting process in one embodiment of the present invention.

FIG. 8 is a block diagram of a computer system useful for implementing the present invention.

### DESCRIPTION OF THE PREFERRED EMBODIMENTS

1. Overview

The present invention, according to a preferred embodiment, overcomes problems with the prior art by providing an efficient and easy-to-implement method for providing customer support to users interacting with a web page. The present invention is meant to compliment existing telephone or instant messaging conversations, allowing customer service representatives to interact directly with the client application they are supporting.

One advantage of the present invention is that there is no need to build a custom client customer service application into the web interface. Preferably, a generic control is embedded into a web page, and this control interacts with a server side customer support application that interacts with the control. Thus, a general facility remotely executes source code (e.g., JavaScript) in the context of a user's application. This allows the customer service interface to be designed specifically for assisting users, and it can even be designed after the end user interface has already been deployed. Additionally, multiple customer service interfaces can exist simultaneously, each for assisting users with a specific aspect of a web application.

Another advantage of the present invention is that there is no need to change web pages or web sites to change the customer support application. The use of a generic control embedded into a web page and a server side customer support application separate from the embedded control means that the update of one of these components does not necessarily require an update of the other. The only requirement is that server side customer support applications are compatible with the embedded control.

Another advantage of the present invention is that any interaction with a remote server is always initiated by the user's web browser. Preferably, the user is prompted before allowing any remote access for additional security. Yet another security advantage is that the embedded control can be implemented in pure Java code, so that the applet security model would only allow the control to connect back to the server it came from. This makes the embedded control remotely accessible to only a representative of the company or entity that owns the web page.

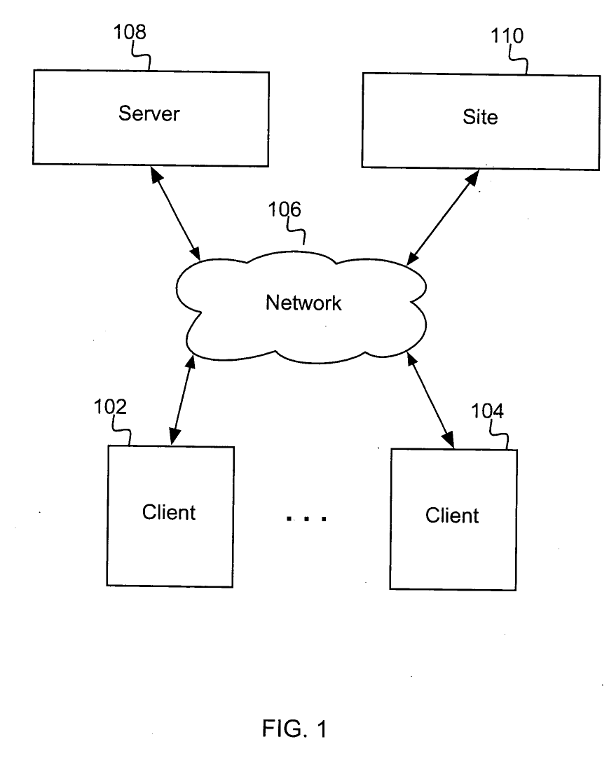

FIG. 1 is a block diagram illustrating the overall system architecture of one embodiment of the present invention. FIG. 1 shows client computers 102 and 104, which are typically utilized by a user to navigate web sites or otherwise download and view web pages. FIG. 1 also shows server 108 and web site 110. Server 108 is any commercially available server system that allows client computers 102 through 104 to exist in a client-server relationship with the server 108. Web site 110 is a conventional web site, generally including a firewall, a web server and a database repository for serving web pages and information to users that visit and navigate through the web site 110.

The operation of the present invention includes the provision of customer support to a client computer, such as client computer 102, from remote entities, such as server 108 or web site 110. In an embodiment of the present invention, a user utilizing a web browser on a client computer 102 encounters a problem with a web page, such as a web page served by web site 110, on his web browser. Subsequently, the user activates a control that is embedded in the web page and enlists the help of customer support from the server 108 or the web site 110. The present invention allows for the embedded control in the web browser to enlist the help of customer support from any remote computer, including a web site 110 external to the network 106 of the client computer 102, a computer on a network external to the network 106 of the client computer 102 or a computer on the network 106 of the client computer 102. The process is described in greater detail below.

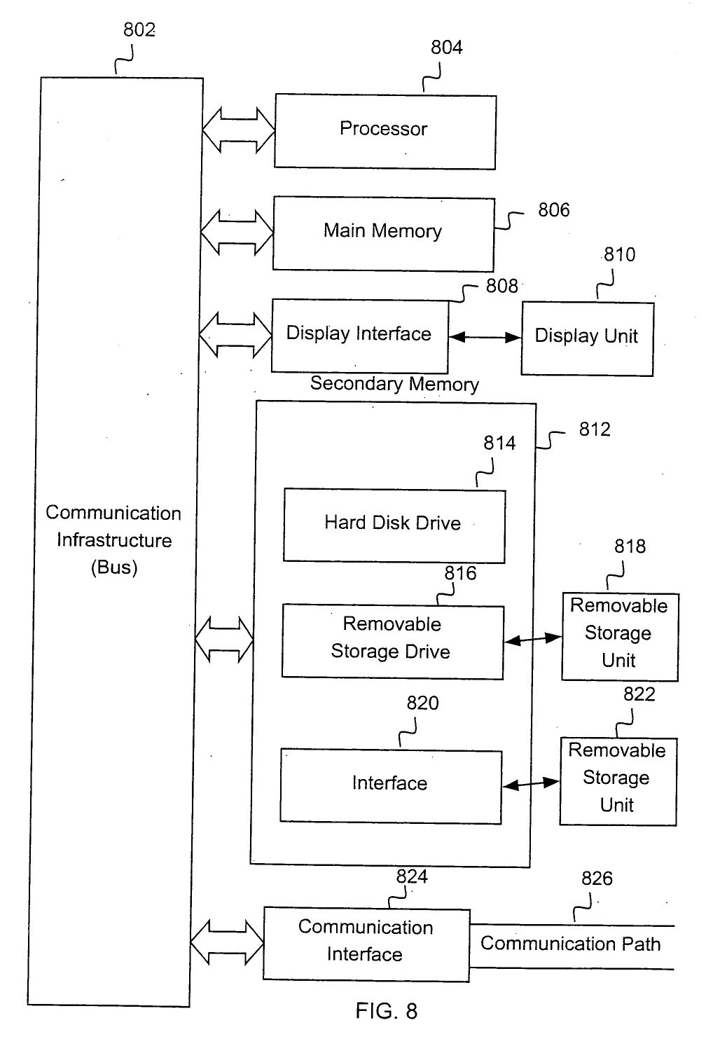

In the preferred embodiment of the present invention, the computer systems of client computers 102 through 104 and server 108 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of server 108 and site 110 are implemented on one or more server systems (e.g., SUN Ultra workstations running the Sun operating system or IBM RS/6000 workstations and servers running the AIX operating system). Exemplary computer systems for client computers 102 through 104, server 108 and site 110 are described in greater detail below with reference to FIG. 8.

In one embodiment of the present invention, the network 106 is a circuit switched network, such as the Public Service Telephone Network (PSTN). In another embodiment, the network is a packet switched network. The packet switched network is a wide area network (WAN), such as the global Internet, a private WAN, a local area network (LAN), a telecommunications network or any combination of the above-mentioned networks. In yet another embodiment, the network is a wired network, a wireless network, a broadcast network or a point-to-point network.

It should be noted that although only two client computers 102 and 104 are shown in FIG. 1, the present invention supports any number of client computers. Likewise, although one server 108 and one web site 110 are shown in FIG. 1, the present invention supports any number of servers and web sites.

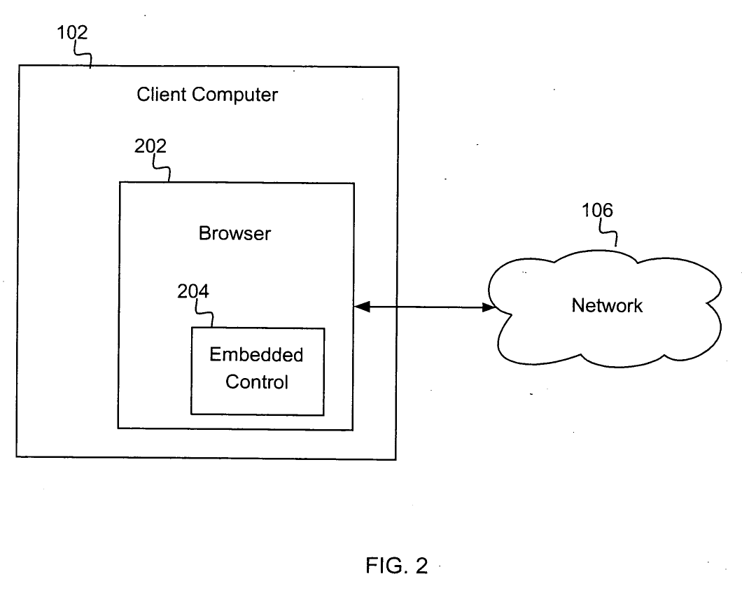

FIG. 2 is a detailed block diagram of the system of a preferred embodiment of the present invention. FIG. 2 shows a conventional web browser 202, such as Microsoft Internet Explorer or Netscape Navigator, executing on a client computer 102. Web browser 202 is any commercially available web browser, which is an application that is typically used to view web pages served by a web site over the Internet. It is shown that the web browser connects to the network 106 for downloading and displaying web pages or other information from a web site 110 or a server 108.

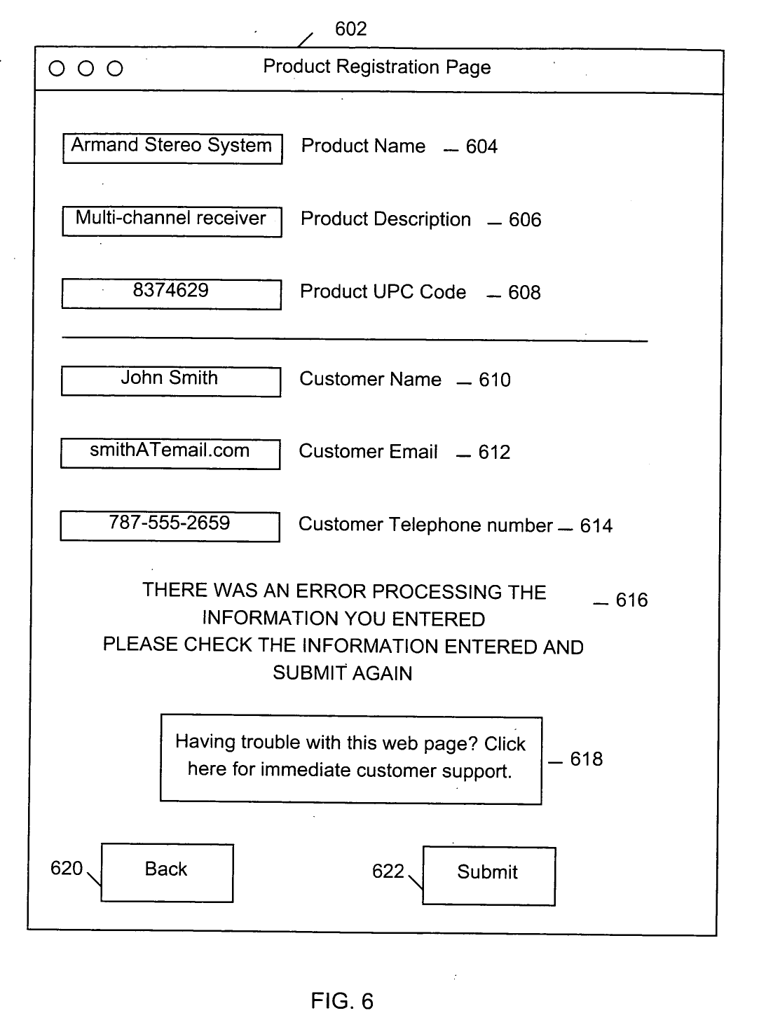

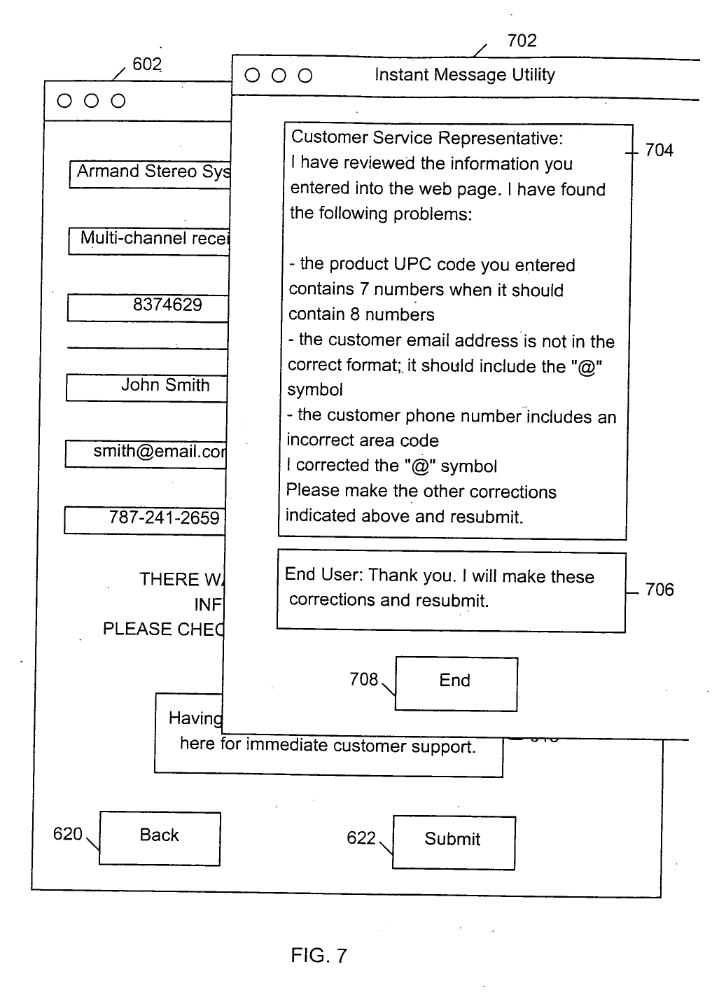

FIG. 2 further shows an embedded web browser control 204. The control 204 operates as a module or sub-element of the web browser 202. In preferred embodiments of the present invention, the control 204 is any one of an ActiveX control, a web browser plug-in, an Application Programming Interface (API) or a Java applet. In some embodiments, the embedded control works in conjunction with JavaScript code on the web page. The control 204 is manifested as a Graphical User Interface (GUI) element (such as a button, a pull down menu or a selection item) located on a menu of the browser 202, a status bar of the web browser 202, or as a GUI element of a web page displayed in the web browser 202. The “embedded” control allows code (e.g., JavaScript code) to be executed within the context of the current page at run-time. An example of an embedded web browser control 204 displayed in the web browser 202 is presented below, with reference to FIGS. 6 and 7.

2. Operation

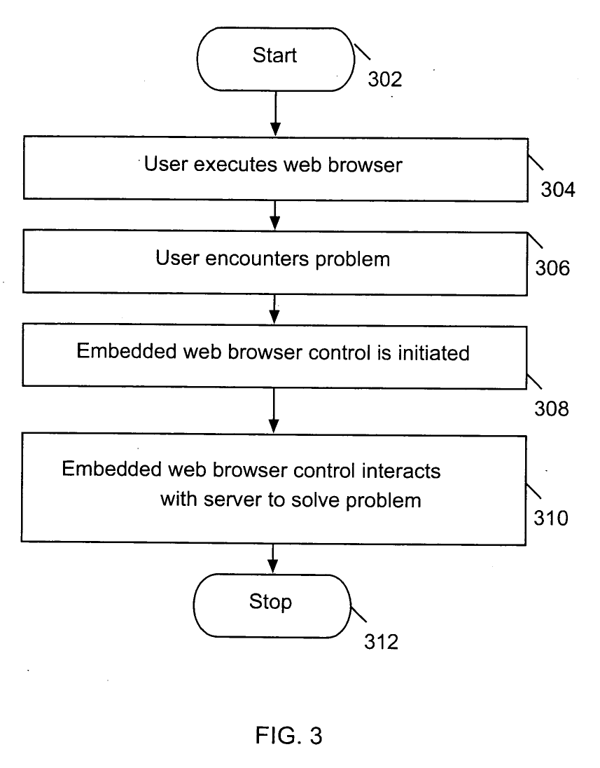

FIG. 3 is a flowchart depicting the overall operation and control flow of one embodiment of the present invention. The operation and control flow of FIG. 3 depicts the overall customer support processes of the present invention. The operation and control flow of FIG. 3 begins with step 302 and proceeds directly to step 304.

In step 304, a user executes a web browser 202. The web browser 202 may be directed by the user to a web page or Universal Resource Locator (URL) with which the user can interact. The web browser requests the URL from a web server and the web server returns the requested HTML resource, which references (embeds) a customer support control. The web browser loads the customer support control so as to invisibly embed it in the page. The web page can also include a form that has form fields, such as text fields and GUI element fields such as buttons and pull down menus, for entering form information.

In step 306, the user encounters a problem with the web page. The user may not understand how to enter information into the form, or the format in which to enter the information. Alternatively, the user may not understand the type of information that must be entered into the GUI elements or the manner in which to navigate the web pages displayed by the web browser 202.

In step 308, in response to the problems encountered by the user, the embedded web browser control 204 is activated and connects to a customer support application on a server (either directly or through a virtual connection, such as via instant messaging). In one embodiment of the present invention, the control 204 is activated by the user. As explained above, the control 204 is manifested in the web browser 202 as a GUI element located on a menu of the browser 202, a status bar of the web browser 202, or as a GUI element of a web page displayed in the web browser 202. The user can click an icon, button or other GUI element that represents the control 204 or use another method of executing the control 204.

In another embodiment of the present invention, the control 204 is activated automatically. In this embodiment, the problem encountered by the user is recognized by the web browser 202, or by the control 204. The web browser 202 or the control 204 may recognize that the user is entering form information improperly into a GUI element of the web page or that the user is expending an inordinate amount of time entering form information in to the form of the web page. Alternatively, the web browser 202 or the control 204 may recognize that the user has submitted form information one or more times and that there is a problem with the form information entered. This example is described in greater detail below with reference to FIGS. 6 and 7. Upon recognition of the problem, the control 204 is automatically activated so as to immediately provide customer support or assistance to the user.

In preferred embodiments of the present invention, the control 204 is cryptographically protected. For example, in some embodiments communication between the control 204 and the server is encrypted to protect the user's privacy. Cryptographic protection of the control 204 can also ensure that the appropriate control 204 is executing on the web browser 202. For example, in some embodiments the control 204 is digitally signed to certify its origin. This proves to the web browser 202 that the control 204 is genuine. Preferably, the requests from the customer service system are digitally signed and authenticated at the client to ensure their validity.

In step 310, the embedded control 204 interacts with the server 108 or web site 110 to allow customer support to be provided to the user. In one embodiment, a customer support representative is engaged at the server 108 or the web site 110 in order to provide customer support to the user. The embedded control has the ability to evaluate source code (e.g., JavaScript code) within the context of the current page at runtime. The customer support representative uses a server side customer support application to interacts with the control 204 by sending source code to the control to perform operations such as querying and/or editing state information of the web browser 202. State information of the web browser 202 includes one or more of the state of the current web page, form information entered into a form of the current web page viewed by the web browser 202, information associated with properties or configuration of the web browser 202 and information associated with the configuration of the client computer 102. Thus, the representative can use the server side customer support application to quickly and easily view the present state of the web page and diagnose the problem. Preferably, the server side customer support application can also be used to modify form values, click buttons, or navigate to another page.

In some embodiments, the customer support representative also employs another method of communication with the user, so as to better facilitate the provision of customer support to the user. Thus, the customer support representative may initiate a telephone call with the user, or the customer support representative may initiate an instant messaging session with the user. This additional line of communication allows the customer support representative to quickly and easily tell the user the problem and what to do to solve the problem, and thus allows the customer support representative to more easily provide customer support to the user. An example of an instant messaging session used for customer support is described in greater detail below with reference to FIGS. 6 and 7.

In one embodiment of the present invention, an automated customer support agent is engaged at the server 108 or the web site 110 in order to provide customer support to the user. The automated agent interacts with the control 204 by sending source code (e.g., JavaScript code) to the control to perform operations such as querying and/or editing state information of the web browser 202. The automated agent is a program or routine that is programmed to recognize common errors or problems encountered during the interaction of a user with particular web pages or a web site 110. The automated agent reacts to the recognition of the problem and proceeds to provide customer support to the user, in a similar manner as an actual customer support representative. The automated agent uses an inference engine or other computerized method to determine the problem encountered by the user and to determine the solution to the problem. Preferably, if the automated agent cannot solve the problem, it transfers the session to an actual representative.

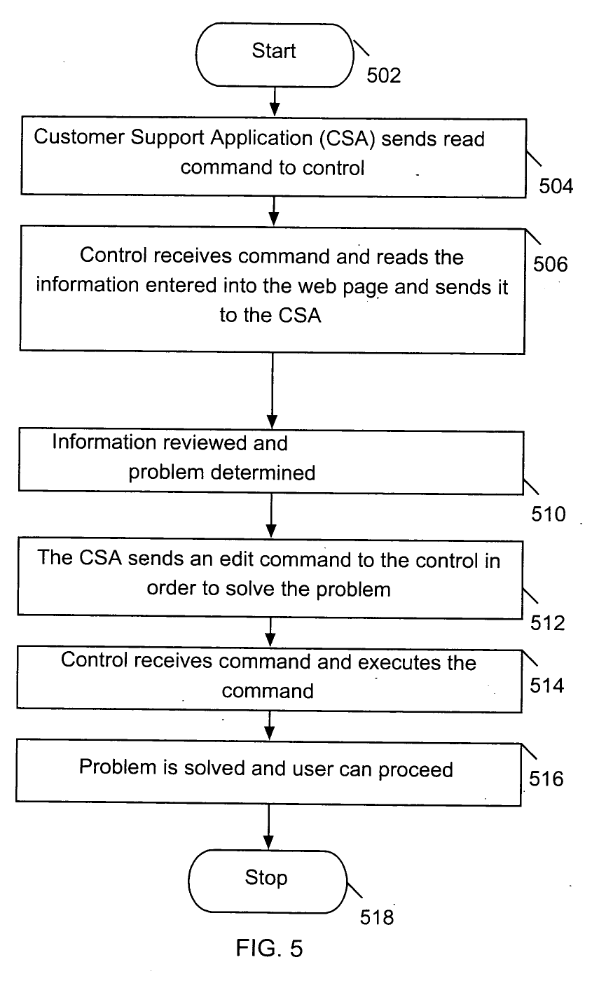

In step 312, the control flow of FIG. 3 stops. The functions of step 310 are described in greater detail below with reference to FIG. 5.

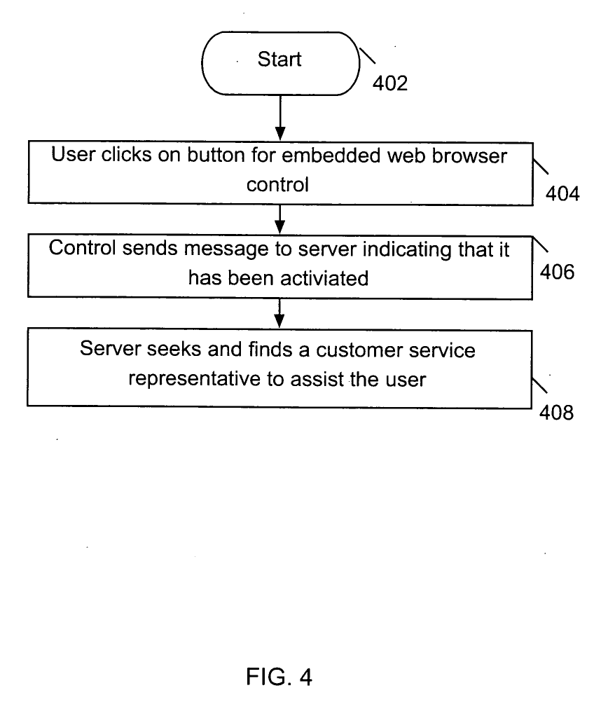

FIG. 4 is a flowchart depicting the operation and control flow of the control activation process of one embodiment of the present invention. The operation and control flow of FIG. 4 provides more detail with regard to step 308 of FIG. 3, depicting the process by which the control 204 is activated. The operation and control flow of FIG. 4 begins with step 402 and proceeds directly to step 404.

In step 404, the user activates the control 204. As explained above, the control 204 is manifested in the web browser 202 as a GUI element located on a menu of the browser 202, a status bar of the web browser 202, or as a GUI element of a web page displayed in the web browser 202. The user can click an icon, button or other GUI element that represents the control 204 or use another method of executing the control 204.

In step 406, the control 204 generates and sends a request or other message to the server 108 or the web site 110 via the network 106. The message is any type of message, such as a TCP/IP message, an SMTP message, an HTTP message, an instant message, a UDP message or a SOAP request (e.g., over HTTP or using instant messaging protocols). The use of an instant message is advantageous as instant messaging protocols usually have an existing mechanism to bypass network firewalls. In alternative embodiments, the embedded control communicates using direct access over a persistent TCP/IP connection or listens for SOAP requests over HTTP. The message indicates to the server 108 or the web site 110 that a user at the client computer 102 is in need of customer support.

In one embodiment of the present invention, the control 204 initiates a communication protocol session with the server 108 or the web site 110. The communication protocol session is utilized by the control 204 and the server 108, or the web site 110 to communicate. This line of communication is used to allow a customer support representative to interact with the control 204, such as to read and edit form information entered into a form of the web page currently displayed on the web browser 202. The Simple Object Access Protocol (SOAP) is an example of a communication session that can be used for communication between the control 204 and the server 108 or the web site 110.

In step 408, in response to the message received in step 406, server 108 or the web site 110 seeks and finds a customer support representative to provide customer support to the user. Alternatively, server 108 or the web site 110 seeks and finds a customer support computerized agent to provide customer support to the user. The customer support representative (or the customer support computerized agent) is engaged at the server 108 or the web site 110 in order to provide customer support to the user. The customer support representative uses a server side customer support application to interact with the control 204 by sending source code to the control to perform operations such as querying and/or editing state information of the web browser 202. Alternatively, an automated customer support agent can be used to interact with the control 204, as described above.

FIG. 5 is a flowchart depicting the operation and control flow of the troubleshooting process of one embodiment of the present invention. The operation and control flow of FIG. 5 provides more detail with regard to step 310 of FIG. 3, depicting the process by which customer support is provided to the user in this exemplary embodiment. The operation and control flow of FIG. 5 begins with step 502 and proceeds directly to step 504.

In step 504, a customer support representative uses a server side customer support application to send a command to the control 204. In preferred embodiments of the present invention, the command is a message indicating an action (such as the reading of state information of the web browser 202) using JavaScript source code or source code in another programming language. The command is sent in a message via the network 106. The message is of any type, such as a TCP/IP message, an SMTP message, an HTTP message, an instant message, a UDP message, or a SOAP message.

In step 506, the control 204 reads the source code and executes it. The control 204 allows for the reception and execution of interpreted language source code. This allows for dynamic customer support that is limited only by the bounds of what can be accomplished by the programming language used. For example, source code can be sent to the control to perform a variety of actions, such as reading, modifying or replacing state information of the web browser 202, opening a new web browser application, opening a new web browser window, viewing a different web page or URL or executing a separate application. Below is an example of JavaScript code that can be sent to the control to read (query) the values of a form in the current web page.

for (var name in document.forms) {

var form = document.forms[name];
for (var element in form.elements) {

// Process form element...

}

}

The source code commands that can be sent by the customer support application include a read command (or query command) for reading certain state information of the web browser 202. State information of the web browser 202 includes one or more of form information entered into a form field of a web page displayed by the web browser 202, information associated with properties or the configuration of the web browser 202 and information associated with the configuration of the client computer 102. Consequently, the state information of the web browser 202 is read and sent to the customer support application at the server 108 or the web site 110.

In step 510, the customer support representative reviews the state information that was received by the customer support application and determines the problem encountered by the user. The user may not understand how to enter information into the form, or the format in which to enter the information. Alternatively, the user may not understand the type of information that must be entered into the form or the manner in which to navigate the web pages displayed by the web browser 202. The form information sent to the customer service application can be all form fields for a generic control, or specific form fields read by a custom control for this page or problem type. The customer service application receives all of this form information from the embedded control. In particular, the form information shows the current state of the form on the user's computer, including what has been filled in by the user. Based on the state information that was received by the customer support application, the customer support representative decides how to proceed.

In step 512, the customer support representative determines the cause of the problem and arrives at a solution. In this example, the customer support representative has determined that the formatting of certain information entered into a form of the web page of the web browser 202 was incorrect. This is easily solved by modifying the entered form information to adhere to the correct format. In step 512, the customer support representative explains the problem to the user (e.g., via instant messaging) and uses the customer support application to send a command to the control to edit the state information of the web browser 202. Here, the command is used to modify certain form information entered into a form of the web page of the web browser 202. Below is an example of JavaScript code that can be sent to the control to modify the value of a text form field named UPC_code.
applicationForm. UPC_code=“56985478”

In step 514, the control 204 receives the source code command and executes it. Here, the source code sent by the customer support application under the control of the customer service representative includes an edit command that operates to modify the state information of the web browser 202. Specifically, the edit command modifies the form information in the form displayed on the current web page of the web browser 202 to correct the problem encountered by the user. In step 516, the problem is corrected so the control shuts down. The user can then proceed.

In one embodiment of the present invention, the customer support representative can also employ another method of communication with the user, so as to facilitate the provision of customer support to the user, during the process of the control flow of FIG. 5. The customer support representative may participate in a telephone call with the user, or the customer support representative may participate in an instant messaging session with the user. An example of an instant messaging session used for customer support is described in greater detail below with reference to FIGS. 6 and 7.

3. Exemplary Implementation

FIG. 6 is an illustration of a web page viewed by a web browser including an embedded control in one embodiment of the present invention. FIG. 6 shows a web page 602 for entering product information for product registration. FIG. 6 shows a list of form fields and identifiers for specifying the type of information that is required by the form on web page 602 in order to register a product. Form field 604 allows a user to enter the name of the product for registration. Form field 606 allows a user to enter a short description of the product for registration. Form field 608 allows a user to enter a Universal Product Code (UPC) or other common identifier for the product for registration. Form field 610 allows a user to enter his name. Each of these form fields can be a GUI element field such as a pull-down menu or a text field that allows the user to directly enter text. Text form field 612 allows a user to enter his email address, and text form field 614 allows a user to enter his telephone number.

Back button 620 allows a user to navigate to a previous web page. Submit button 622 allows a user to submit his registration and commence the registration process for his product. The web page 602 further includes a text message 616. This message 616 appeared on the web page 602 after the user entered form information into the form of web page 602 and submitted the form information. A process reviewed the form information entered into the web page 602 and determined that some of the form information was incorrect or was formatted incorrectly. As a result, the text message 618 was displayed, indicating that there was a problem with the form information entered into the web page 602.

The button 618 represents the control 204. The button 618 includes a text message indicating that if the user is having trouble with the web page 602, he can click on the button 618 to receive customer support. Clicking of the button 617 activates the control 204 and commences the process represented by step 308 of FIG. 3. The button 618 can always be displayed on web page 602, or can appear after incorrect form information was submitted.

FIG. 7 is an illustration of an instant message window used during the troubleshooting process in one embodiment of the present invention. FIG. 7 shows an instant message window 702 for communication between the user and a customer support representative. The instant message window 702 is initiated after the control 204 has been activated by the user by clicking on button 618.

FIG. 7 shows that instant message window 704 includes a text area 704 that includes text that is typed by the customer support representative. Instant message window 704 further includes a text area 706 that includes text that is typed by the user. End button 708 allows the user to end the communication with the customer support representative.

As indicated in the text area 704, the customer support representative has used the embedded control to read the form information entered by the user in the form of the web page 602 and identified the problems encountered by the user. The customer support representative indicates that the problems are as follows: 1) the product UPC code entered by the user in form field 608 is missing one number, 2) the email address entered by the user in the text form field 612 is not in the correct format—a “@” symbol is missing from the email address, and 3) the area code of the telephone number entered by the user in text form field 614 is incorrect. The customer support representative explains the above problems to the user in form field 704 and uses the embedded control to correct the second error. Subsequently, the user replies in text area 706 that he will make the other corrections and resubmit the web page 602.

In preferred embodiments of the present invention, the customer support representative need not ask the user to make all of the corrections. In such embodiments, the customer support representative can send an edit command to the control 204 in order to make appropriate changes. This is discussed in greater detail above.

4. Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 8 is a block diagram of a computer system useful for implementing an embodiment of the present invention. For example, the computer system of FIG. 8 can be a representation of computers 102 through 104 or server 108. Various software embodiments are described in terms of this exemplary computer system. After reading this description, it will become apparent to a person of ordinary skill in the relevant art(s) how to implement the invention using other computer systems and/or computer architectures. The computer system of FIG. 8 includes one or more processors, such as processor 804. The processor 804 is connected to a communication infrastructure 802 (e.g., a communications bus, cross-over bar, or network).

The computer system can include a display interface 808 that forwards graphics, text, and other data from the communication infrastructure 802 (or from a frame buffer) for display on the display unit 810. The computer system also includes a main memory 806, preferably random access memory (RAM), and may also include a secondary memory 812. The secondary memory 812 may include, for example, a hard disk drive 814 and/or a removable storage drive 816, representing a floppy disk drive, a magnetic tape drive, an optical disk drive, etc. The removable storage drive 816 reads from and/or writes to a removable storage unit 818 in a known manner. Removable storage unit 818, represents, for example, a floppy disk, magnetic tape, optical disk, etc. which is read by and written to by removable storage drive 816. As will be appreciated, the removable storage unit 818 includes a computer usable storage medium having stored therein computer software and/or data.

In alternative embodiments, the secondary memory 812 may include other similar means for allowing computer programs or other instructions to be loaded into the computer system. Such means may include, for example, a removable storage unit 822 and an interface 820. Examples of such may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to the computer system.

The computer system may also include a communications interface 824. Communications interface 824 allows software and data to be transferred between the computer system and external devices. Examples of communications interface 824 include a modem, a network interface (such as an Ethernet card), a communications port, and a PCMCIA slot and card. Software and data transferred via communications interface 824 are in the form of signals which may be, for example, electronic, electromagnetic, optical, or other signals capable of being received by communications interface 824. These signals are provided to communications interface 824 via a communications path (i.e., channel) 826. This channel 826 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 806 and secondary memory 812, removable storage drive 816, a hard disk installed in hard disk drive 814, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 806 and/or secondary memory 812. Computer programs may also be received via communications interface 824. Such computer programs, when executed, enable the computer system to perform the features of the present invention as discussed herein. In particular, the computer programs, when executed, enable the processor 804 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for providing support to a user from a remote computer, the method comprising:
activating a control embedded in a web page that is currently being viewed by a web browser;
receiving source code from the remote computer; and
using the control to execute the source code received from the remote computer so as to read and/or modify state information of the web browser.

2. The method of claim 1, wherein the state information of the web browser includes form information entered into at least one form field of the web page that is currently being viewed by the web browser.

3. The method of claim 2, wherein the using step includes the sub-steps of:
executing the source code so as to read the form information; and
sending the form information that is read to the remote computer.

4. The method of claim 1, wherein the using step includes the sub-step of executing the source code so as to modify at least one form field of the web page that is currently being viewed by the web browser.

5. The method of claim 1, further comprising the step of:
after the activation step and before the receiving step, sending a message from the control to the remote computer to establish a connection between the control and a support application executing on the remote computer.

6. The method of claim 1, wherein the using step includes the sub-step of executing the source code so as to cause the web browser to view a different web page.

7. A computer readable medium including computer instructions for providing support to a user from a remote computer, the computer instructions including instructions for performing the steps of:
activating a control embedded in a web page that is currently being viewed by a web browser;
receiving source code from the remote computer; and
using the control to execute the source code received from the remote computer so as to read and/or modify state information of the web browser.

8. The computer readable medium of claim 7,
wherein the state information of the web browser includes form information entered into at least one form field of the web page that is currently being viewed by the web browser, and
the using step includes the sub-steps of executing the source code so as to read the form information, and sending the form information that is read to the remote computer.

9. The computer readable medium of claim 7, wherein the using step includes the sub-step of executing the source code so as to modify at least one form field of the web page that is currently being viewed by the web browser.

10. The computer readable medium of claim 7, wherein the computer instructions further including instructions for performing the step of:
after the activation step and before the receiving step, sending a message from the control to the remote computer to establish a connection between the control and a support application executing on the remote computer.

11. A control for embedding in a web page to allow support to be provided to a user from a remote computer, the control comprising:
means for sending a message to the remote computer to establish a connection between the control and a support application executing on the remote computer;
means for receiving source code from the remote computer; and
means for executing the source code received from the remote computer so as to read and/or modify form information entered into at least one form field of the web page.

12. The control of claim 11, wherein the means for executing executes the source code so as to read the form information, and sends the form information that is read to the remote computer.

13. A method for providing support to a user of a remote computer from a customer service computer, the method comprising:
receiving, at the customer service computer, a message from a control embedded in a web page that is currently being viewed by a web browser executing on the remote computer;
sending source code from the customer service computer to the control so as to cause the control to read and/or modify state information of the web browser executing on the remote computer.

14. The method of claim 13,
wherein the state information of the web browser includes form information entered into at least one form field of the web page that is currently being viewed by the web browser, and
the sending step includes the sub-steps of:
sending the source code from the customer service computer to the control so as to cause the control to read the form information; and
receiving, at the customer service computer, the form information that is read.

15. The method of claim 13, wherein the sending step includes the sub-step of sending the source code from the customer service computer to the control so as to cause the control to modify at least one form field of the web page that is currently being viewed by the web browser.

16. A customer support application for providing support to a user of a remote computer from a customer service computer, the method comprising:
means for receiving, at the customer service computer, a message from a control embedded in a web page that is currently being viewed by a web browser executing on the remote computer;
means for sending source code from the customer service computer to the control so as to cause the control to read and/or modify state information of the web browser executing on the remote computer.

17. The customer support application of claim 16,
wherein the state information of the web browser includes form information entered into at least one form field of the web page that is currently being viewed by the web browser, and
the means for sending sends the source code from the customer service computer to the control so as to cause the control to read the form information, and receives the form information that is read.

18. The customer support application of claim 16, wherein the means for sending sends the source code from the customer service computer to the control so as to cause the control to modify at least one form field of the web page that is currently being viewed by the web browser.
